(19) United States
(12) Patent Application Publication
(10) Pub. No.: US 2017/0176031 A1
(43) Pub. Date: Jun. 22, 2017

(54) Dual Control Thermostat

(71) Applicant: Steve Gayle Morgan, Phoenix, AZ (US)

(72) Inventor: Steve Gayle Morgan, Phoenix, AZ (US)

(21) Appl. No.: 14/809,103

(22) Filed: Jul. 24, 2015

(51) Int. Cl. F24F 11/00; G05B 15/02

(52) U.S. Cl. CPC F24F 11/006; G05B 15/02

(57) ABSTRACT

A dual control climate controlling system (thermostat) that gives the control of an HVAC system to two separate parties—an authoritative body such as an administration of a facility and the room occupant—in a balance of control that satisfies the needs of both parties with minimal detrimental effects to the other. The administration has ultimate control over the HVAC system management and decides how much control it wants the room occupant to have. The administration has a comprehensive set of software driven tools within the device that allow it to enable or disable any control feature of the thermostat. There are automatic features that return control settings back to the administration's settings after allowing the room occupant to make changes to achieve comfort for himself This is a non-deniable system, that is, the room occupant can effect changes without the need for a password.

### Sequence Listing or Program

This application contains two embedded controllers programmed with the following firmware. The first, embedded controller 21 (main processing component), runs “Main.hex” firmware. The second, embedded controller 22 (keypad encoder and clock), runs “KeypadClock.hex.”

### BACKGROUND—PRIOR ART

The following is a list of relevant prior art:

U.S. Patents

| Patent Number | Kind Code | Issue Date | Patentee |
|---|---|---|---|
| 6,644,557 | B1 | Nov. 11, 2003 | Jacobs |
| 8,020,780 | B2 | Sep. 20, 2011 | Finch |
| 8,195,313 | B1 | Jun. 5, 2012 | Fadell |

Having been a facilities engineer at a college campus for many years now, I've run into a need for a dual control climate controlling device (thermostat) that gives an administration control of an HVAC system yet allows the room occupant (students in the dorms, professors in the classrooms, persons in chapel, etc.) control as well so they may use the room with reasonable comfort. The climate controlling device must contain a set of tools to perform the necessary functions to allow the two parties the ability to control the HVAC system and satisfy the needs of both. The room occupant needs to have the ability to use the room in comfort and the administration needs to have the ability to set reasonable guidelines and eliminate wasted energy. It is desirable the climate controlling device be a self contained device so that anybody with reasonable skills may install it without the need for professional installation. Not being able to find such a device in the marketplace, I developed it myself. Seeking to secure patent rights, I discovered there is nothing in prior art that describes a thermostat that fits this description.

Prior art addresses some of the problems associated with giving any person in the room control of the HVAC system but does not address the many problems associated with dual control of an HVAC system. The purpose of dual control is to allow a responsible party such as an administration control over the HVAC system yet also allow the room occupant control over the system as well. Prior art makes many attempts at giving an authoritative body control over the HVAC system. Some devices do so by implementing various limited access features such as password systems or other exclusionary devices. Or, in other instances, they limit the range of temperature settings the room occupant can use by fixed or adjustable settings. This is useful but falls way short of being an effective device for satisfying the needs of both parties. In order to achieve a finely balanced dual control system, a very selective set of functions must be incorporated into the climate controlling device.

For example, there must be a way for a room occupant, say a professor, to have enough control of the HVAC system to make a classroom he enters comfortable enough to use. He or she must not be excluded from using the classroom because they cannot exhibit any control over the HVAC system. There are many examples in prior art that use exclusionary means, such as a password system, to exclude certain persons from accessing control of the HVAC system, but professors entering a classroom must have the ability to use that room if they need to. The climate controlling device must not cause a professor to be disabled from using a classroom because he either hasn't been told the password or he has forgotten it. Colleges use adjunct professors that are not part of the every day classroom experience hence to rely upon them to know the HVAC passwords for the classroom cannot be relied upon. Also, professors are always calling the IT department because they cannot access a piece of computer software because they forgot a password so relying on all of them to always remember all the HVAC system passwords cannot be relied upon. And a professor starting a class 20 minutes late because he spent that time looking for someone to give him the password to the HVAC system is not acceptable. The alternative, to leave the classroom HVAC system open for anyone to walk in and do what they please is also not acceptable. Another means of control is needed. This present invention allows the administration to shut off the HVAC system because the room is not usually used at certain times but allows the room occupant, in this case the professor, to walk in and use the room without a password by engaging the override feature on the device. He does this simply by pressing the “1” key on the keypad. This will turn the HVAC system on to a comfortable temperature setting that was set by the administration earlier.

Giving a professor the ability to turn the HVAC system on is good and satisfies his needs but that does not address the problems the administration now has to face with eliminating wasted energy if he forgets to turn it off (and how they forget to turn it off!). If the professor leaves the classroom with the HVAC system still running, there may not be anyone else using the classroom for a long period of time. All the energy used to keep the room at a comfortable level during that time will have been wasted. While this is not a problem for the professor, it is for the administration who will be paying the extra money for the wasted energy on the electric bill. So, among the many software tools this device has to maintain dual control is a timer that automatically shuts the HVAC system off after the override period has timed out. The override time period is adjustable and is set by the administration. Thus both parties have been satisfied. The professor was able to turn the HVAC system on and use the room and the administration has been satisfied because the system did not run wastefully.

Just as there are times when the administration may turn the HVAC system off but allow the room occupant the ability to turn it on, there may also be times when the administration may want to be able to turn the HVAC system off and not allow anyone to turn it on. This may be the case during the summer time when the campus is shut down, for example. This control can be achieved by the administration and it is explained later. It is the purpose of this device to grant dual control, but also to give the administration final say in that control.

There must also be a way for an administration, if they want to, to eliminate the wasted energy caused by someone turning the fan switch to “On” instead of “Auto”. This often occurs causing the fan to run for sometimes weeks at a time with no one noticing. Someone in chapel, for example, may turn the switch to on to move the air during a service and leave the room that way. It has often been observed that the fan has been running for weeks and no one knew it. This control can also be achieved by the administration and it, too, is explained later.

There must also be a way to maintain a balance of control over the HVAC system between the administration and the students in the dorm rooms. The administration needs to have the ability to maintain a sense of order in the dorms by not allowing the students to set the room temperature to a very high or very low level. Students come from all over the world being used to different climate conditions, some from Alaska and some from warmer regions. The thermostat in one room often affects the temperature not only in that room but the rooms next to it. And it has been found that students left in complete control of the HVAC system is not acceptable. The students need to have the ability to make adjustments to make the room comfortable but the administration needs to have control over the HVAC system to make sure the room temperature stays within a reasonable level. Students often turn the A/C down to around 60 degrees and snuggle under blankets in their room. This wastes electricity and causes the air conditioning unit to run almost constantly. It also causes students in the other dorm rooms to complain their room is too cold. There must be a way to maintain a balance of control between the administration and the students. This device does this by allowing the administration to set minimum and maximum settings for both heating and cooling. The students can adjust the room temperature but only within a range set by the administration.

There must also be a way to keep the room occupant from “playing” with the thermostat trying to make the room cooler and in the process changing the thermostat schedule settings. This problem has been observed frequently. Once again the maintenance department is called to figure out why the A/C is running on a Saturday when no one is there only to find the schedule had been messed up by someone earlier in the week. The administration must have the ability to set a schedule and know that it will remain intact without being tampered with by the room occupant. Also, to require a password to access control of the thermostat as is often stated in prior art is not acceptable since such password access would not only give access to adjust the room temperature settings but also the schedule. Once again, this device addresses these problems where prior art does not.

Another problem sometimes encountered is the room occupant changing the “Off-Heat-Cool” switch position. While this may be desirable sometimes, sometimes it is not. Often there are several A/C units cooling the same room, hence, if one of them goes bad or has a problem it is not always readily noticed because the other units are working to cool the room. It has been observed many times that the switch on one or more of the units had been placed on heat while the other units were on cool. Once again, it was probably someone in a hurry “playing” with the thermostat trying to make the room colder and they accidentally changed the switch position. It is sometimes desirable for the administration to have the ability to not allow this switch position to be changed by the room occupant. Once again, this device gives the administration such control.

And the most important thing to be stressed here is there needs to be the ability to perform all of the above tasks in a single device and not just some of them. If all the above problems cannot be addressed together in a single device then the device does not address the problems of dual control and granting the administration ultimate authority over the HVAC system. And the ability to satisfy the needs of a room occupant and an administration have not been met. Exercising one or more of the above features in a device does not fulfill the requirements of dual control and such a device is not useful to me. Nothing in prior art describes a device that can address all these problems.

There is a long list of prior art shown in U.S. Pat. No.6,644,557 B1 issued to Jacobs on Mar. 25, 2002. While these inventions address the problems associated with allowing anyone entering a room to make changes to the HVAC system control, none of them, including the one just mentioned, solve the problems of dual control of an HVAC system. They provide different lock-out mechanisms and ease of use methods and range controls without providing the very selective set of functions needed to solve the many problems encountered when allowing dual control of an HVAC system.

### SUMMARY

In one embodiment the thermostat has a keypad with 12 keys. These keys are used to input all information into the thermostat. The thermostat displays information back out to the user via an LCD display. In one embodiment this display has 4 lines with 20 characters per line. The administration has the ability to set a vast array of operating parameters by entering the thermostat into administration mode via a password. The thermostat is designed in such a way that this password should never be given to anyone outside of the administration. The room occupant controls the system without the need for a password. When the administration is finished setting up the system's features in the way they want it to operate, they place the thermostat into occupant mode by pressing the pound key.

The thermostat gives the administration the ability to have full control over the HVAC system yet it allows the room occupant the ability to control the HVAC system as well. The administration determines what that level of control is to be. The administration may enable or disable different features and set minimum and maximum temperature settings for both heating and cooling. Features they can enable or disable are the override switch, the fan switch (on/auto), the off-heat-cool switch, the temp up button, and the temp down button. Only the administration can set the program schedule for the thermostat. The purpose of this device is to give control of the HVAC system to two parties, a ruling party such as an administration and the room occupant, in such a way that the needs of both are met with little adverse affects on the other while at the same time giving the administration ultimate authority over the HVAC system.

### DRAWINGS—FIGURES

FIG. 1 shows the enclosure

FIG. 2 shows the top side of the circuit board

FIG. 3 shows the bottom side of the circuit board

FIGS. 4A to 4C are the schematic

FIG. 5 shows one embodiment of the display screen

### DRAWINGS—REFERENCE NUMERALS

11 the enclosure
12 keypad
13 hole
14 display window
15 connector, keypad, 0.1″
16 buzzer, piezoelectric
17 chrystal, 1.8432 MHz
18 variable resistor, 100 k
19 transistor, PN2222A
20 display, 4×20
21 embedded controller, ATMEGA1284
22 embedded controller, ATMEGA168A
23 circuit board
24 relay, 5V 2A latching
25 relay, 5V 2A latching
26 relay, 5V 2A latching
27 voltage regulator, LM7805, 5V
28 bridge rectifier, 1A
29 metal oxide varistor, 56V
30 resistor, 100 ohm, ½ W, 5%
31 resistor, 10K ohm, ¼ W, 5%
32 thermistor, 10K ohm, 5%
33 resistor, 10K ohm, ¼ W, 1%
34 resistor, 10 ohm, flameproof, 5%
35 resistor, 47K ohm, ¼ W, 5%
36 capacitor, 22pf
37 capacitor, 22pf
38 capacitor, 10 uF
39 capacitor, 10 uF
40 capacitor, 10 uF
41 capacitor, 220 uF
42 capacitor, 220 uF
43 diode, 1N914
44 diode, 1N914
45 diode, 1N914
46 diode, 1N914
47 diode, 1N914
48 diode, 1N914
49 diode, 1N914
50 diode, 1N914
51 diode, 1N914
52 diode, 1N914
53 diode, 1N914
54 diode, zener, 15V
55 connector, terminal block, 5.08 mm, 6 position

### DETAILED DESCRIPTION

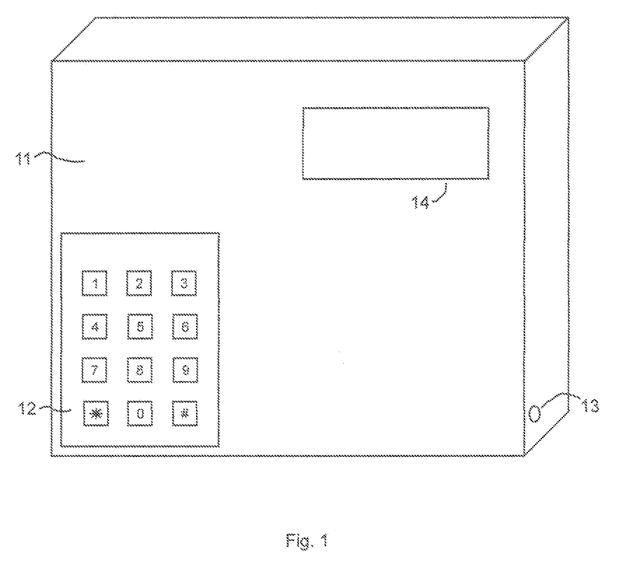

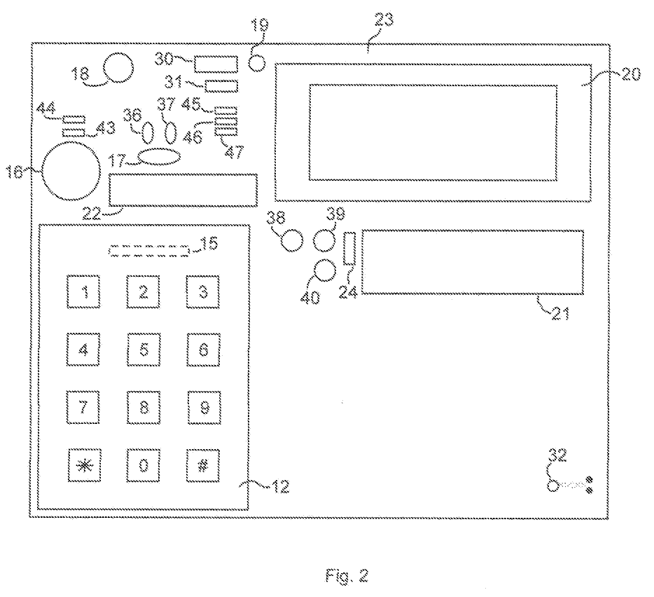

This paragraph describes FIG. 1 details. One embodiment of the enclosure is illustrated in FIG. 1. Plastic enclosure 11 is used to contain all the components of the thermostat. Hole 13 in the side of enclosure 11 is used to allow the temperature of the room to be sensed by temperature sensing device 32 (FIG. 2). Keypad 12 is mounted to the outside of enclosure 11 and is thereby accessible. Clear window 14 allows LCD display 20 (FIG. 2) to be seen. In one embodiment the enclosure is 6 inches wide, 5 inches tall, and 1 ½ inches deep.

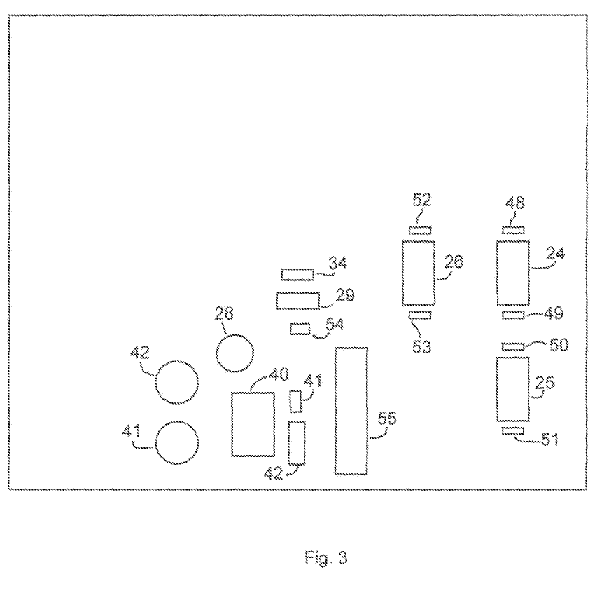

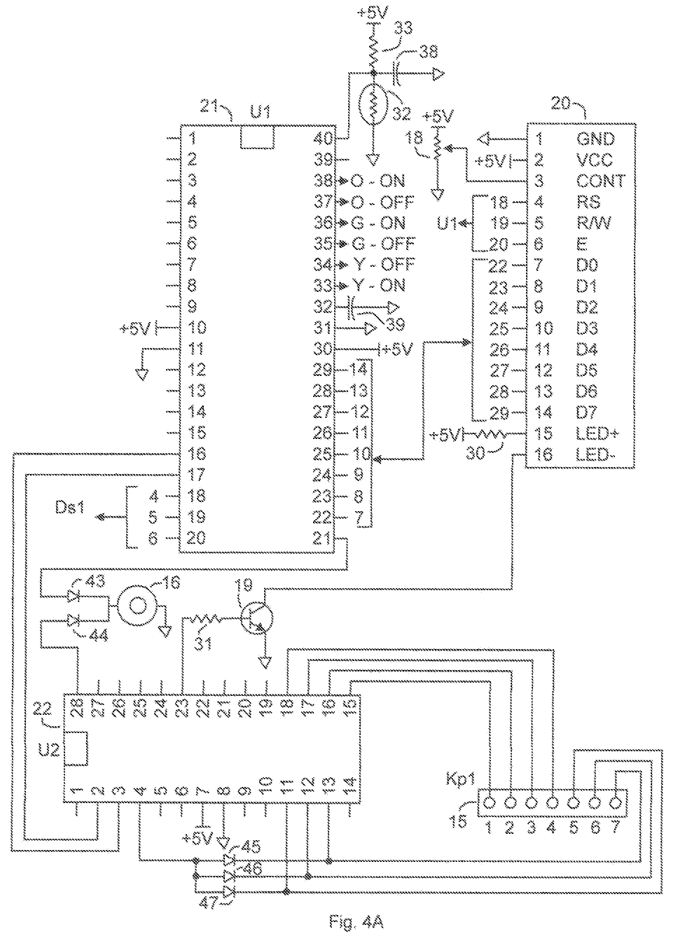

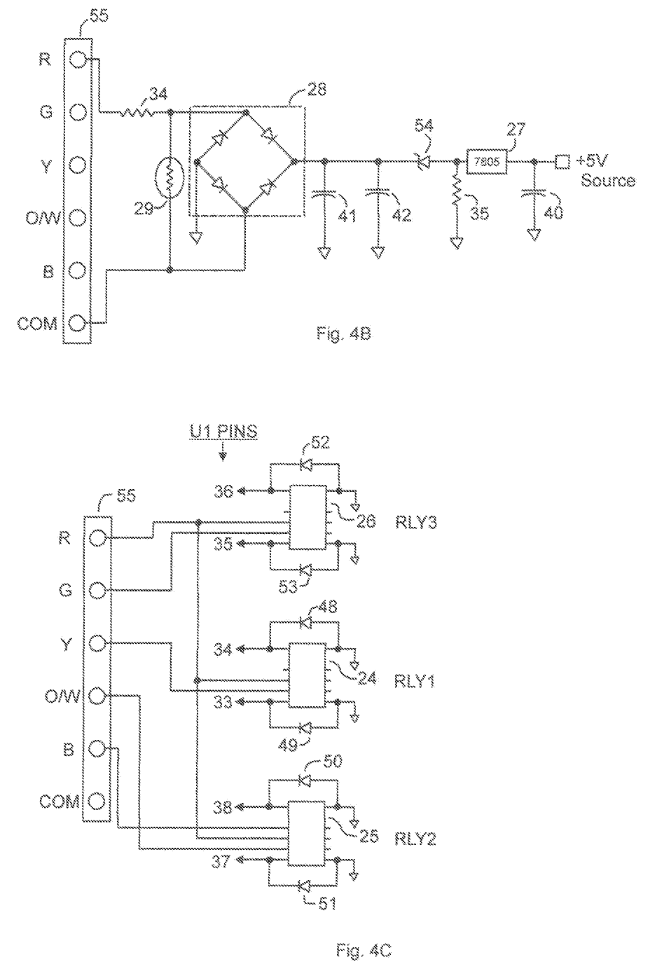

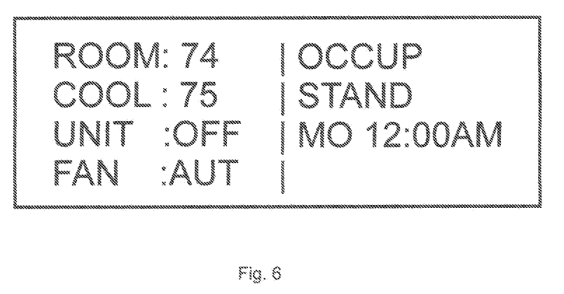

This paragraph describes components mounted to circuit board 23. The front side of circuit board 23 is shown in FIG. 2 and the back side of circuit board 23 is shown in FIG. 3. All electronic components of the thermostat are mounted/soldered to circuit board 23. These components include embedded controller 21 (main processing component), embedded controller 22 (keypad encoder and clock), variable resister 18, buzzer 16, crystal 17, thermistor (temperature measuring device) 32, bridge rectifier 28 (FIG. 3), resistors 30-35, diodes 43-54 (diode 54 is a zener diode), capacitors 36-42, keypad connector 15, terminal block (thermostat wire connector) 55 (FIG. 3), transistor 19, voltage regulator 27 (FIG. 3), metal oxide varistor 29 (FIG. 3) and relays 24, 25, and 26.

### Operation

### Hardware

This section describes components mounted to circuit board 23 shown in FIG. 2 (front) and FIG. 3 (back). All electronic components of the thermostat are connected to circuit board 23. Embedded controller 21 is the heart and brains of the thermostat and embedded controller 22 is used as the keypad encoder and clock. Variable resistor 18 is used to set the contrast of display 20. Capacitors 36 and 37 are used in conjunction with chrystal 17 to set the clock of embedded controller 21 to a very precise frequency of 1.8432 MHz. Resistor 30 is used as a current limiter for the backlight LED of display 20. Transistor 19 is used as a switch to turn on the backlight for display 20. Resistor 31 is a current limiting resistor for the base of transistor 19. Display 20 is used to display information to the user.

Resistor 32 is a thermistor that changes resistance as the temperature changes. It is wired in a voltage divider network with resistor 33 and is used to measure the room temperature. Because accuracy is important, resistor 33 is a 1% tolerance resistor (most resistors are typically rated to be accurate to their rated value within 5%). The voltage is taken from the junction of thermistor 32 and resistor 33 and fed to embedded controller 21 where it is processed in firmware.

Capacitor 39 is used as a filter capacitor for the Aref pin on embedded controller 21. Capacitor 38 is used as a filter for the voltage coming from thermistor 32 and ensures a more accurate temperature reading. Capacitor 40 is used as filter for the Vcc power line. Keypad 12 is connected to circuit board 23 through connector 15. Keypad 12 is used to input information into the thermostat. Buzzer 16 is used to give the user an audible feedback during keypresses and other operations. Diodes 43 and 44 are used for electrical isolation to allow the thermostat to use only one buzzer (instead of two) for both embedded controller 21 and embedded controller 22. Diodes 45, 46, and 47 are all used in conjunction with keypad 12 and are used to drive the interrupt pin on embedded controller 22 to a low state when a key is pressed. Diodes 48 to 53 short the voltage kickback from the relay coils.

The reverse side of circuit board 23 is shown in FIG. 3. Bridge rectifier 28 is used to convert the AC voltage from the HVAC system (the 24V AC from its control voltage transformer) to a DC voltage. Capacitors 41 and 42 act as filter capacitors that follow bridge rectifier 28. Resistor 34 is used as an absorber of a voltage spike should one occur. Metal Oxide Varistor 29 is used to shunt the voltage to a safe level should a voltage spike occur. Voltage regulator 27 is used to regulate the voltage level to 5 volts. Diode 54 is a 15 volt zener diode used to drop the voltage input to the voltage regulator by 15 volts. Relay 24 is used to activate the Y contact of the thermostat. Relay 25 is used to activate the G contact of the thermostat. Relay 26 is used to activate the O contact of the thermostat. (“Is used to activate” refers to connecting the terminal [G, Y, or O] to the power terminal which is the “R” terminal.)

### Software

When the thermostat is first powered up, display 20 will display “Booting . . . ” on line 1 and a second or so later on line 3 will display “Press any key to enter Setup”. During this time if a key is pressed the thermostat will enter Installer mode. The display will read “Enter Password”. Next the master password will need to be entered. If the correct master password is entered the thermostat will display “Installer”. Next press “1” to set the subbase type. If “1” in pressed the display will read “Sub=1” meaning the subbase type is set for heat pump. Press “1” if you want to keep the subbase type as heat pump (or it will time out in a few seconds) or press “2” to set the subbase type to gas heat. The thermostat will time out and recycle back to “Booting . . . ”. During the boot process if no key is pressed when the display reads “Press any key to enter Setup” the thermostat will after a few seconds proceed to normal operation.

When the thermostat is powered up and operating in normal operation, display 20 will display information as shown in FIG. 6. The word “Room:” is displayed and next to it is displayed the room temperature, in this case it reads 74 degrees. Below this is displayed the word “Off” or “Heat” or “Cool” which will be indicating the mode the thermostat is currently in. Just to the right of the colon will read the temperature the thermostat is set at. If it is in cooling mode, it will display the cool temperature setting and the same goes for heat. FIG. 6 shows the thermostat set for cooling and it is set for 75 degrees. Below this will be displayed the word “Unit:” and next to it will be the current status of the HVAC system. If the HVAC system is running, it will read “RUN” here. If the thermostat is not running, it will read “Off” here. Below this is displayed the word “Fan:” and next to it it will display the status of the fan switch which is either “Aut” for auto or “On” for on. In this case it is displaying “Aut”. The next set of displayed information starts at column 11. It will display the mode the thermostat is in. It will either display “Admin” for administration or “Occup” for occupant. In this case it is displaying “Occup” for occupant mode. Below this is displayed the mode of operation, either “Stand” for standard mode or “Sched” for schedule mode. In this case it is displaying “Stand” for standard mode. Below this will be displayed the clock information including the day of the week, the hour, and the minutes and next to this it will read “am” or “pm”.

To place the thermostat in administration mode, press the “#” key and then enter the proper four digit password. Either one of the three standard passwords can be entered or the master password. The display should now read “Admin”. All the administration functions are now available.

Pressing the “1” key will display “Set Cool Min”. Below it should be displayed the current cool minimum temperature the thermostat will allow. A new value can be entered at the keypad. For example, pressing the seven key followed by the eight key will change the setting to 78 degrees. This setting is affective when the thermostat is in standard mode.

Pressing the “2” key will display “Set Cool Max”. Below it should be displayed the current cool maximum temperature the thermostat will allow. A new value can be entered at the keypad. For example, pressing the seven key followed by the three key will change the setting to 73 degrees. This setting is affective when the thermostat is in standard mode.

Pressing the “3” key will display “Set Heat Min”. Below it should be displayed the current heat minimum temperature the thermostat will allow. A new value can be entered at the keypad. For example, pressing the six key followed by the three key will change the setting to 63 degrees. This setting is affective when the thermostat is in standard mode.

Pressing the “4” key will display “Set Heat Max”. Below it should be displayed the current heat maximum temperature the thermostat will allow. A new value can be entered at the keypad. For example, pressing the seven key followed by the three key will change the setting to 73 degrees. This setting is affective when the thermostat is in standard mode.

Pressing the “5” key will display “Override”. Pressing the “1” key next will display “Set OR Length”. Next enter the length of time you want the override to be. This number will be multiplied by 30 minutes. Two numbers need to be entered. So, for example, if you want the override length of time to be one hour you would enter “0” then “2”. If instead of pressing the “1” key after entering the override mode you pressed the “2” key, the display will read “Set OR Cool”. Below it should be displayed the current override cool setting. A new value can be entered at the keypad. For example, pressing the seven key followed by the three key will change the setting to 73 degrees. If instead of pressing either the “1” key to set the override length or pressing the “2” key to set the override cool setting you pressed the “3” key, the display will read “Set OR Heat”. Below it should be displayed the current override heat setting. A new value can be entered at the keypad. For example, pressing the six key followed by the seven key will change the setting to 67 degrees. These settings are used when, for example, a professor enters a classroom unexpectedly and needs to use the room. In warmer weather the administration may have the room temperature set very high to save energy. The professor can, simply by pressing the “1” key, activate the temporary override feature that will turn the HVAC system on to this preset cool temperature setting so he can use the room comfortably and it will shut itself off automatically after the override period times out. He may also turn the override feature off simply by pressing the “2” key as he leaves the room. Either way it will go back to the administration setting that is was set at before the override was activated. In one embodiment the thermostat will beep a few minutes before returning the HVAC system back off to warn the professor his time is about up. In any case, he may press the “1” key again which will start the timeout period all over again.

Pressing the “6” key will display “Deviation”. Below it will be displayed the current deviation amount the thermostat will allow. A new value can be entered at the keypad. For example, pressing the “2” key will change the deviation amount to 2 degrees. The deviation amount is used when the thermostat is in schedule mode. In this mode the administration has control over the room temperatures and the room occupant has none. The deviation is another software tool that allows the administration to set a schedule of temperature settings but also allow the room occupant to adjust the room temperature somewhat for his or her comfort. That amount is dictated by whatever the administration decides to set the deviation amount to be. For example, if the administration has the schedule set so that at a particular time the (mode is cooling) temperature is set to 75 degrees and the deviation amount is 2 degrees, the room occupant may lower the room temperature down to as low as 73 degrees or raise it to as much as 77 degrees if he so chooses to do so. The idea is to satisfy the administration by giving him control over the HVAC system but yet allow the room occupant to be satisfied by being able to adjust the temperature closer to his comfort level. The deviation may be set anywhere from zero to nine.

Pressing the “7” key will display the time. The first line displays the day and the second line displays the hours and minutes. Pressing the “1” key will advance the minutes. Pressing the “2” key will advance the hours. Pressing the “3” key will advance the day of week.

Pressing the “8” key will display the schedule. FIG. 6 shows the schedule as displayed on the screen. The schedule will start by displaying Monday event 1 information. The time will be blinking since it can be set at this point. Pressing the “3” key will advance the minutes to the next 15 minute mark. For example, if the time is 7:12 am and the “3” key is pressed, the time will advance to 7:15 am. Pressing it again will advance it to 7:30 am. Pressing the “6” key will do the same increments only backwards. So, for example, pressing the “6” key when the time is displaying 7:42 am will change the setting to 7:30 am. Keys “2” and “5” are special adjustment keys. They are also used to set the time but in single increments. Pressing the “2” key will advance the time by one minute. Pressing the “5” key will decrement the time by one minute. To advance the schedule to change the cool temperature setting, press the “9” key. (Pressing the “7” key moves the schedule backwards.) Pressing the “9” key again will cause the temperature next to heat to blink indicating the heat setting may now be changed. Pressing the “9” key again will advance the schedule to the next event, in this case Monday Event 2. Once Monday Event 4 is reached, advancing the schedule will move to Tuesday Event 1 and so on.

Pressing the “9” key will display the lock modes. When the “9” key is pressed, the display will read “Lock Modes”. Pressing the “1” key next will display “Enable Key”. Next press the key you want to enable. Pressing it will enable the key and thus enable the room occupant to use that key's function. If after pressing the “9” key the “2” key was pressed, the display will read “Disable Key”. Pressing a key at this point will disable the key and thus disable the room occupant from using that key's feature. Pressing the “3” key will display “Full Lock”. At this point every key is locked except the “#” key. Pressing the “4” key will display “Full Unlock”. At this point all keys will be unlocked. The purpose of the lock modes is to allow the administration to set what functions they want to allow the room occupant to be able to use. So, for example, if there has been a problem with people turning the fan switch to “On” and leaving the room and the fan is kept running for a long time, the administration may disable the “5” key (fan mode key) and the room occupant cannot change the fan mode from auto to on anymore. The lock modes is a software tool that gives the administration control over the HVAC system and allows them to dictate the amount of control the room occupant can have.

Pressing the “0” key will display “Passwords”. In order to enter this mode of operation, the master password must have been entered. Pressing the “1” key will display “Sta” meaning standard. Next press “1”, “2”, or “3” for password number one, two, or three. In one embodiment there are three standard passwords. For our example we will press the “1” key. Next enter a four digit password. The thermostat will remember this as standard password number one. We could have pressed the “2” key to save the password as standard password number two. We also could have pressed the “3” key to save the password as standard password number three. Going back to the beginning, pressing the “2” key after pressing the “0” key will display “Mas” for master password. Next enter a four digit password and the thermostat will remember it as the master password.

Pressing the “#” key will return the thermostat to occupant mode. At this point the administration functions are no longer available. To enter administration mode again, press the “#” key followed by either the master password or one of the three standard user passwords. With the thermostat now in Occupant Mode, the following functions are available to the user. The administration may choose to lock any of the features below by locking the appropriate key as just explained.

Pressing the “1” key engages the override feature. This will cause the thermostat temperature settings to change from its current settings to the override settings.

Pressing the “2” key disengages the override feature. When this key is pressed the thermostat settings will return to what they were before the override feature was activated

Pressing the “3” key raises the temperature setting by one degree. This is true whether the thermostat is in cooling mode or heating mode.

Pressing the “4” key shifts the mode from “Off” to “Cool” to “Heat”. For example, if the current setting is cooling mode and this key is pressed, the mode will shift to heating. If the current mode is heating and this key is pressed, the mode will shift to off.

Pressing the “5” key toggles the fan mode between “Auto” and “On”.

Pressing the “6” key lowers the temperature setting by one degree. This is true whether the thermostat is in cooling mode or heating mode.

Pressing the “7” key toggles the mode between Schedule mode and Standard mode. When the thermostat is in Schedule mode, the thermostat will follow a schedule for the temperature setting. That is, software will check the day and time of day and assign the temperature setting for that particular time. When the thermostat is in Standard mode, the schedule data is ignored and the thermostat operates as a simple non-programmable thermostat.

Keys 8-11 (key 9 meaning “*” and key 10 meaning “0” here) are not functional. They are reserved for future use in firmware upgrades.

Pressing the “#” key followed by a correct password will enter the thermostat into Administration Mode from here. When the thermostat is in Administration Mode and the “#” key is pressed, the thermostat will return to Occupant Mode. (No password is necessary to go from Administration Mode to Occupant Mode.) It also acts as a return key.

### Conclusion, Ramifications, and Scope

The reader may imagine that, with a firmware based electronic system such as this, an exhaustive array of variations are possible and therefor an exhaustive number of embodiments here are possible, but the fundamental or common feature here is to provide a set of software tools that allows dual control of the climate managing system. An administration needs to control the thermostat so that some sense of order may be maintained and wasted energy can be eliminated. But at the same time since the room occupant is actually the one occupying the room and therefor should share in the equation of balance, he should also be able to control the HVAC system. It is this fair balance of control that is the heart of this design. Variations in power supply design, power source, enclosure type, display line count, keypad count or design, number of stages, communications port presence or design, etc. are all important design features, but it is the balance of control between two parties and satisfying the needs of both are the invention's focus. A comprehensive set of operating features has been provided in software to allow such balance possible.

The features include giving the administration the ability to set a schedule and know that it cannot be tampered with by the room occupant. Allowing the room occupant the ability to turn the HVAC system on and to allow him to do so without a password not only frees him from the burden of having to remember another password in order to use the room but also keeps him from having the ability to effect changes in the schedule (since giving him a password would allow him access to the administration functions). Another part of the comprehensive set of operating features is the ability of the thermostat to return to operating settings set by the administration automatically after allowing the room occupant the ability to control the room temperature enough to comfortably use it. Various fundamental means of adding exclusivity of control by use of passwords, etc. is not effective in maintaining dual control of the HVAC system. A software driven method of complex control arrangements has been provided here to achieve the result of providing a means of control over an HVAC system by two separate parties in order that both parties may achieve their goals. Only two features have been listed here to display the role of dual control, but there are many more incorporated in the design as was seen earlier.

It could be noted that my examples refer to a college setting with professors, etc., but dual control of the HVAC system is an important control scheme and therefor useful in other settings as well. The college setting is one familiar to me and therefor used in my examples, but these rules apply in many other settings as well. Commercial properties are mainly the focus here, but anywhere where two parties need a balance of control, this invention is extremely useful.

I claim:

1. A room temperature controlling device with features that allow two separate parties, a ruling body such as an administration and also a room occupant, to have control over the HVAC system in such a way that the needs of both parties are satisfied, comprising:
a. a keypad used by both said administration and said room occupant to input data into the device,
b. a display used to give the operating information of said device to said administration or to said room occupant,
c. a computer processing board used to contain electronic components of the system including said output display,
d. a software program that provides a comprehensive set of tools whereby said two parties can have a balance of control between them for the purposes of satisfying the needs of both by:
1. providing a two mode system of operation, an administration mode and a room occupant mode, with qualifying entry into said administration mode by use of a password, but allowing control in said room occupant mode by said room occupant without a password, and
2. providing an override function for said room occupant to use by pressing the “1” key on said keypad which causes the temperature setting to change from the administration's energy savings setting to a comfortable setting for said room occupant, and then automatically returning to said administration's said energy savings setting by using a timer by which said override, that was engaged by said room occupant, will automatically deactivate and return said temperature setting to said administration's energy savings setting, and
3. enabling said administration to set maximum and minimum temperature settings for both heating and cooling,
4. allowing said administration to have the ability to enable or disable keys on said keypad for when said device is in said occupant mode in order to allow or disallow said room occupant the ability to activate specific functions. Said specific functions include: switching the Off-Cool-Heat mode, switching the Auto-On Fan Mode, switching said override on, temp up, and temp down, and
5. enabling said administration to set a schedule and said room occupant cannot change it,
e. and providing all the above components and functions together in a single device for the purposes of establishing a dual control system,
whereby two separate parties can control an HVAC system with both parties being able to perform their needed functions with minimum detrimental effects to the other.
